(19) United States
(12) Patent Application Publication
(10) Pub. No.: US 2024/0281033 A1
(43) Pub. Date: Aug. 22, 2024

(54) SCREEN PROTECTOR WITH ENGRAVED IMAGE

(71) Applicants: Clay CANNING, Lakeland, FL (US); RaShaun BROWN, Houston, TX (US)

(72) Inventors: Clay CANNING, Lakeland, FL (US); RaShaun BROWN, Houston, TX (US)

(73) Assignee: SCREEN SKINZ, INC., Lakeland, FL (US)

(21) Appl. No.: 18/653,531

(22) Filed: May 2, 2024

Related U.S. Application Data
(63) Continuation-in-part of application No. 16/543,417, filed on Aug. 16, 2019.
(60) Provisional application No. 62/750,199, filed on Oct. 24, 2018.

(51) Int. Cl. G06F 1/16; H04M 1/02

(52) U.S. Cl. CPC G06F 1/1637; H04M 1/0266; G06F 2200/1634

(57) ABSTRACT

A screen protector including a screen protector substrate having an image etched on a top surface thereof formed by micro-fractures in the top surface created by a laser and activated by a chemical process, the image being visible when installed on an inactivated screen through light passing through unetched portions of the image and the image being transparent/translucent on an activated screen. A method of making a screen protector, by etching an image into a screen protector substrate by striking a top surface of the screen protector substrate with a laser and creating micro-fractures in the top surface, forming intervals that allow light to pass through unetched portions of the image, applying a chemical compound, applying an anti-fingerprinting coating, and applying an adhesive layer for adhering the screen protector substrate to a screen. A method of protecting a screen and displaying an image.

### BACKGROUND OF THE INVENTION

### 1. TECHNICAL FIELD

The present invention relates to compositions and methods for protecting screens of objects and smart devices. More specifically, the present invention relates to tempered glass screen protectors having an image engraved thereon.

### 2. BACKGROUND ART

Screen protectors are placed on top of objects with a screen in order to protect the screen from scratches and cracking as well as reduce glare from sunlight or reduce risk of water penetrating the screen. Screen protectors are used with smart phones, tablets, laptop/computer screens, television screens, and more. They are generally thin substrates made of glass or plastic that adhere to the screen. Preferably, screen protectors allow for use of a touchscreen without interference.

Screen protectors have also been designed with aesthetic effects. For example, U.S. Patent Application Publication No. 2013/0059117 discloses a display screen protecting film that incorporates vanishing graphical elements. The images are embedded in the film by way of reflective metal particles. The images appear under ambient light and seem to vanish when the underlying screen of a device is illuminated. However, the metal particles do not fully disappear, and show up as a watermark when the device is illuminated. This remaining image can be distracting when the device is on.

There remains a need for a screen protector that displays an image when a screen is not illuminated but fully disappears when the screen is illuminated and in use.

### SUMMARY OF THE INVENTION

The present invention provides for a screen protector including a screen protector substrate having an image etched on a top surface thereof, the image being formed by micro-fractures in the top surface created by a laser and activated by a chemical process, the image being visible when installed on an inactivated screen through light passing through unetched portions of the image and the image being transparent/translucent on an activated screen.

The present invention provides for a screen protector and screen, including a screen protector substrate having an image etched on a top surface thereof, the image being formed by micro-fractures in the top surface created by a laser and activated by a chemical process, the screen protector substrate operatively attached to the screen through an adhesive layer on a bottom surface of the screen protector substrate, the image being visible when the screen is inactivated through light passing through unetched portions of the image and the image being transparent/translucent when the screen is activated.

The present invention provides for a method of making a screen protector, by etching an image into a screen protector substrate by striking a top surface of the screen protector substrate with a laser and creating micro-fractures in the top surface, forming intervals that allow light to pass through unetched portions of the image, applying a chemical compound to the screen protector substrate to activate the image and remove residual material, applying an anti-fingerprinting coating to the screen protector substrate, and applying an adhesive layer for adhering the screen protector substrate to a screen.

The present invention provides for a method of protecting a screen and displaying an image, by installing the screen protector onto the screen, wherein the screen protector includes the screen protector substrate having the image etched on a top surface thereof, the image being formed by micro-fractures in the top surface created by a laser and activated by a chemical process, and displaying the image when the screen is not activated through light passing through unetched portions of the image, and the image becoming translucent or transparent when the screen is activated.

### DESCRIPTION OF THE DRAWINGS

Other advantages of the present invention are readily appreciated as the same becomes better understood by reference to the following detailed description when considered in connection with the accompanying drawings wherein:

FIG. 1 is a diagram of an example screen protector with engraved image;

FIG. 2 is a diagram of an example screen protector with engraved image being installed on a screen of a device;

FIG. 3 is a diagram of an example screen protector with engraved image installed on a screen of a device;

FIG. 4 is a diagram of an example screen protector with engraved image installed on a screen of a device having a backlight of the screen activated;

FIG. 5 is a diagram of a side view of an example screen protector with engraved image being installed on a screen of a device;

FIG. 6A shows a screen protector, FIG. 6B shows a device, and FIG. 6C shows an example screen protector with engraved image installed on a screen of a device wherein the device screen is not illuminated; and

FIG. 7A shows a screen protector, FIG. 7B shows a device, and FIG. 7C show an example screen protector with engraved image installed on a screen of a device having a backlight of the screen activated.

### DETAILED DESCRIPTION OF THE INVENTION

The present invention generally provides for a screen protector, shown at 100 in the FIGURES, having an image 104 engraved thereon, wherein the image 104 is visible when a backlight of a screen 204 that the screen protector 100 is installed on is not activated and the image 104 becomes transparent and/or translucent when the backlight of the screen 204 that the screen protector 100 is installed on is activated.

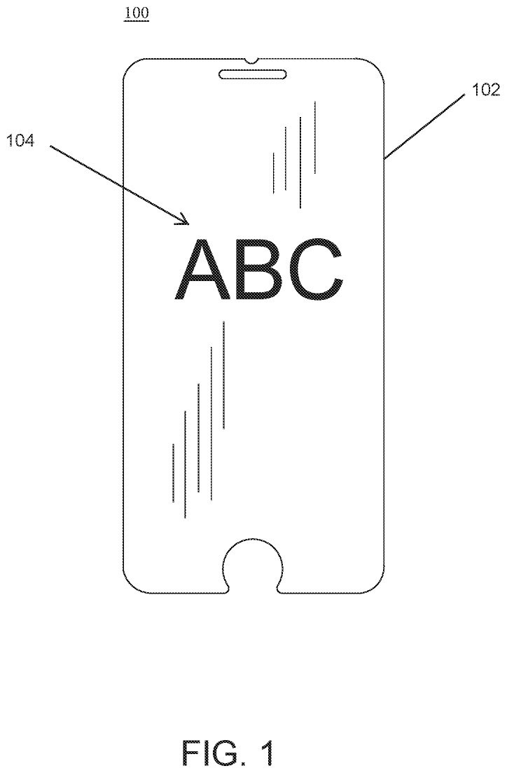

FIG. 1 is a diagram of an example screen protector 100 with engraved image 104. The screen protector 100 includes a screen protector substrate 102. The screen protector substrate is most preferably tempered glass, but can also be plastic, wood, fabric, metal, fiber, stone, natural, man-made, synthetic, artificial or composite material. The tempered glass can have a thickness of 0.1 mm to 0.4 mm with a tempering range between 4 H-9 H (hardness).

The screen protector substrate 102 has an image 104 engraved or etched into a top surface of the screen protector substrate 102. The top surface can be a surface of the screen protector substrate 102 that is facing away from a screen 204 when the screen protector substrate 102 is installed on the screen 204 or, in other words, the surface that is not in contact with the screen 204.

The image 104 can include graphical images, letters, numbers, symbols, etc. In general, any graphical image and/or alphanumeric image can be included in image 104.

The image 104 can be engraved or etched into the screen protector substrate 102 using a mechanical technique, a laser etching technique, a chemical technique, and/or any other suitable technique. Portions of the screen protector 100 can be removed leaving only the portions that form the image 104. The etching process creates precise, micro-scale patterns on the top surface of the screen protector substrate 102, most preferably when the screen protector substrate is tempered glass. These patterns are strategically designed to modulate light transmission, enabling the underlying display to remain visible through the etched areas.

More specifically, the image 104 is created by micro-fracturing the screen protector substrate 102 in fragments/patterns with an etching machine by striking the top surface of the screen protector substrate 102 with a laser between 5 Watts and 100 Watts and with speeds between 5 mm/s and 1500 mm/s. This laser technique allows for an image 104 to be created with a resolution DPI (dots per inch) of 50-2400. The laser can be a CO2 or fiber laser. Striking the screen protector substrate 102 with the laser in patterns to form the image 104 forms intervals that allow light to pass through the unetched portions of the pattern, which makes the image 104 invisible. The fractures are on the scale of microns and do not extend entirely through the screen protector substrate 102. The intervals are based on the specific image 104 itself and they are automatically scattered with a software program to obtain a desired shade of black/gray.

After the screen protector substrate 102 has been etched with the desired image 104, a chemical technique can be performed. More specifically, a chemical compound is applied by micro-injection (i.e., liquid is injected at a microscopic level) that activates the image 104, causing it to become visible to the naked eye and removes any residual glass (or other material) fragments within the etched area of the image 104, ensuring a smooth feel and clean appearance. In other words, when the screen protector substrate 102 is etched in the etching machine the image 104 is not visible, but after applying the chemical compound, the image 104 is visible. The chemical compound can be water or an alcohol such as methanol, ethanol, propan-2-ol, butan-1-ol, pental-1-ol, hexadecane-1-ol, ethane-1,2-diol, propane-1,2-diol, propane-1,2,3-triol, butane-1,2,3,4-tetraol, pentane-1,2,3,4,5-pentol, hexane-1,2,3,4,5,6-hexol, heptane-1,2,3,4,5,6,7-heptol, prop-2-ene-1-ol, 3,7-dimethylocta-2,6-dien-1-ol, prop-2-yn-1-ol, cyclohexane-1,2,3,4,5,6-hexol, or 5-methyl-2-(propan-2-yl)cyclohexan-1-ol. The screen protector substrate 102 can also be polished in order to remove any glass fragments.

The screen protector substrate 102 can further include an anti-fingerprint (AF) coating on the top surface. The effectiveness of the AF coating is demonstrated through a water drop test, wherein the glass exhibits a contact angle ranging between 100 degrees and 150 degrees. Thee AF coating can be applied when manufacturing the screen protector substrate 102 raw materials by methods known in the art.

A bottom surface of the screen protector substrate 102 can include an adhesive layer for adhering to the screen 204 of a device 202, and preferably the adhesive layer allows for the screen protector substrate 102 to be secured to a screen 204 but also allows for its removal when needed. The adhesive layer can preferably be acrylate-based glue, but can also be silicone-based adhesive, rubber-based adhesive, polyurethane adhesive, pressure-sensitive adhesive, hot melt adhesive, or UV-curable adhesive. The adhesive layer is applied with a controlled thickness ranging from 90 micrometers to 300 micrometers. A protective film can be applied over the adhesive layer to protect it before application to a screen. Alternatively, the screen protector substrate 102 can adhere to the screen 204 through an electrostatic layer or electrostatic properties of the material of the screen protector substrate 102 itself.

The present invention provides for a method of making the screen protector 100, by etching an image 104 into the screen protector substrate 102 by striking the top surface of the screen protector substrate 102 with a laser and creating micro-fractures, forming intervals that allow light to pass through unetched portions of the image 104, applying a chemical compound to the screen protector substrate 102 to activate the image 104 and remove residual material, applying an anti-fingerprinting coating to the screen protector substrate 102, and applying an adhesive layer for adhering the screen protector substrate 102 to a screen 204. Most preferably, the screen protector substrate 102 is made of tempered glass. These steps can be performed as described above.

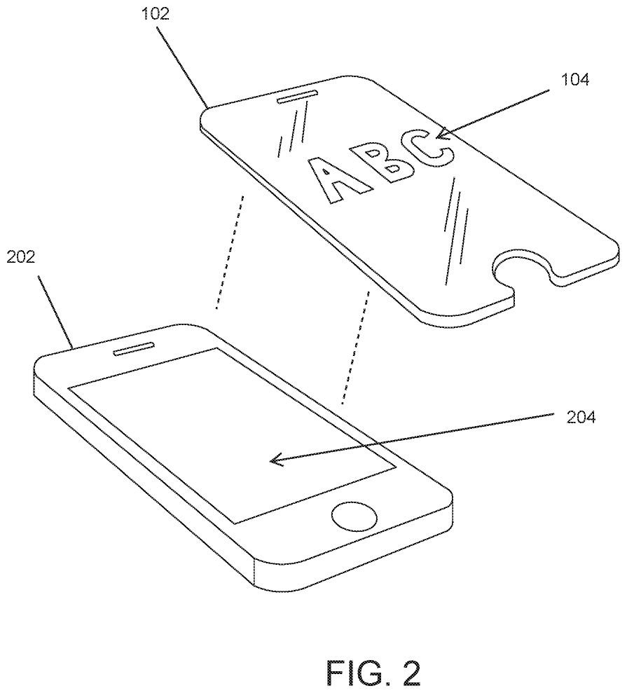

FIG. 2 is a diagram of an example screen protector 100 with engraved image 104 being installed on a screen 204 of a device 202. In particular, the screen protector substrate 102 with the image 104 engraved or etched thereon is shown in a process of being installed onto a screen 204 of a device 202. The screen protector substrate 102 with the engraved or etched image 104 can be installed on the screens 204 of devices 202 such as mobile phones, tablet computers, laptop computers, flat screen monitors, flat screen televisions, a watch face (e.g., mechanical, electronic or computerized watches or wearable devices), display screens on buildings, windows, appliances, furniture, product displays, a vehicle light (e.g., a headlight, a tail light, a fog light, etc.), a vehicle window, a vehicle windshield, or a vehicle interior display screen. In general, the screen protector substrate 102 with engraved or etched image 104 can be installed on any backlit display or non-backlit (e.g., organic light emitting diode (OLED)) display screen 204.

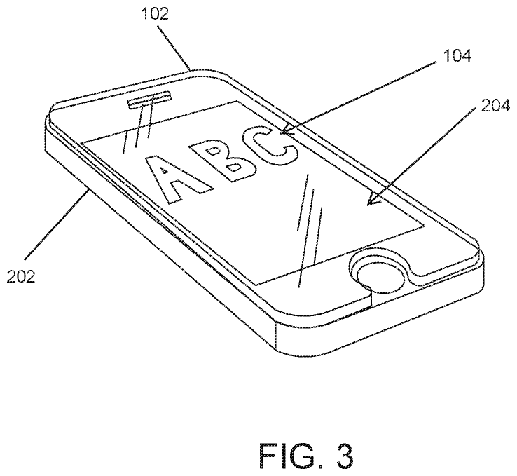

FIG. 3 is a diagram of an example screen protector substrate 102 with engraved image 104 installed on the screen 204 of the device 202

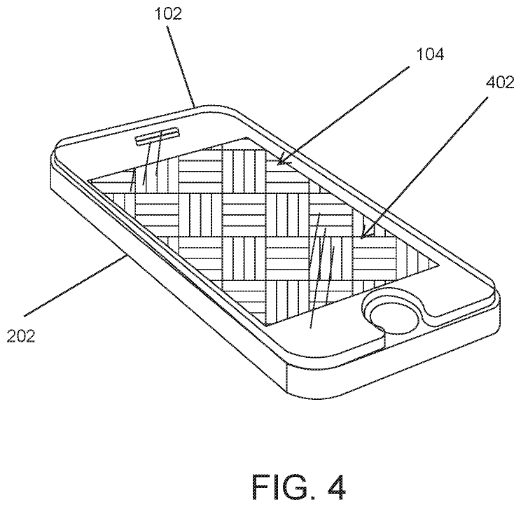

In FIG. 4, a light (e.g., backlight or internal light source) of a display screen 204 has been activated and the image 104 is no longer visible because the image 104 becomes translucent and/or transparent when a light source of the display screen 204 is activated and a screen image 402 becomes visible.

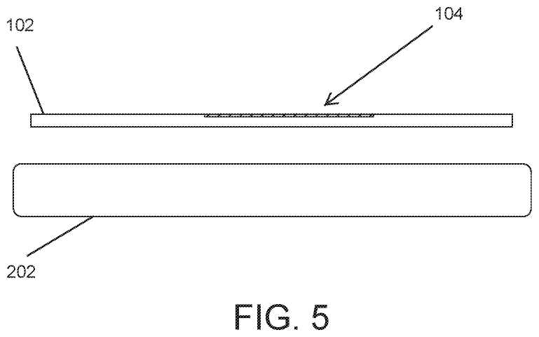

FIG. 5 is a diagram of a side view of an example screen protector 100 with engraved image 104 being installed on a screen 204 of a device 202. In particular, the screen protector substrate 102 with the image 104 is shown being installed on the device 202.

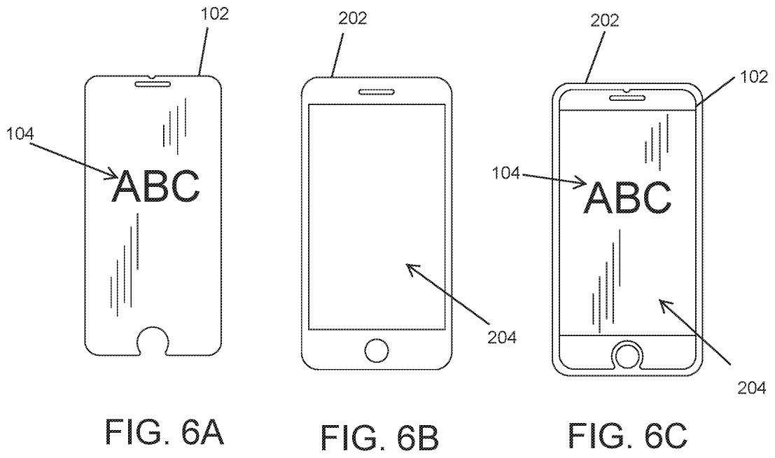

FIGS. 6A to 6C show a sequence of an example screen protector 100 with engraved image 104 being installed on a screen 204 of a device 202. FIG. 6A shows the screen protector substrate 102 with engraved or etched image 104 prepared to be installed on the screen 204 of the device 202 shown in FIG. 6B. FIG. 6C shows the screen protector substrate 102 with engraved or etched image 104 installed on the screen 204 of the device 202 with a backlight (or other light source) of the display not activated such that the image 104 is visible.

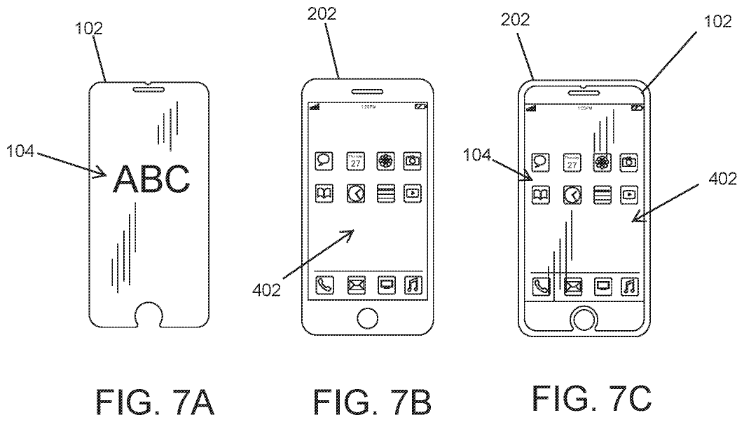

FIGS. 7A to 7C show a sequence of an example screen protector 100 with engraved image 104 being installed on a screen 204 of a device 202. FIG. 7A shows the screen protector substrate 102 with engraved or etched image 104 prepared to be installed on the screen 204 of the device 202, shown in FIG. 7B, which has its display activated with a backlight (or other light source) and shows a screen image 402. FIG. 7C shows the screen protector substrate 102 with engraved or etched image 104 installed on the screen 204 of the device 202 with a backlight (or other light source) of the display activated such that the image 104 is not visible and the screen image 402 is visible.

The present invention provides for a method of protecting a screen 204 and displaying an image 104, by installing the screen protector 100 onto the screen 204, wherein the screen protector 100 includes the screen protector substrate 102 having the image 104 etched on a top surface thereof, the image 104 being formed by micro-fractures in the top surface created by a laser and activated by a chemical process, and displaying the image 104 when the screen 204 is not activated through light passing through unetched portions of the image 104, and the image 104 becoming translucent or transparent when the screen 204 is activated. The screen protector 100 is as described above. The installing step can further include applying the screen protector substrate 102 to the screen 204 through an adhesive layer on a bottom surface of the screen protector substrate 102.

There are several advantages to the present invention. The method reduces time and production costs, because with a laser a custom design (image 104) can be made in minutes. The image 104 itself is marked using scattered dots, the dots are subject to the image shading. Once the laser marks the image 104, the chemical process is applied to make the image 104 show/activate, once activated the user can apply to a screen, once the screen turns on the back-lit display allows light to transmit through the design (image 104), making the design appear as if it is transparent and one does not see the design.

The invention is further described in detail by reference to the following experimental examples. These examples are provided for the purpose of illustration only, and are not intended to be limiting unless otherwise specified. Thus, the invention should in no way be construed as being limited to the following examples, but rather should be construed to encompass any and all variations which become evident as a result of the teaching provided herein.

### Example 1

In one example, an image is formed on a screen protector using a dithering technique on a design, and the design then is etched with a laser onto the screen protector. Once it is etched, a chemical is applied by hand onto the screen protector, once it is applied, the screen protector is polished to remove any additional glass and to remove any fingerprints.

Throughout this application, various publications, including United States patents, are referenced by author and year and patents by number. Full citations for the publications are listed herein. The disclosures of these publications and patents in their entireties are hereby incorporated by reference into this application in order to more fully describe the state of the art to which this invention pertains.

The invention has been described in an illustrative manner and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A screen protector comprising a screen protector substrate including an image etched on a top surface thereof, said image being formed by micro-fractures in said top surface created by a laser and activated by a chemical process, said image being visible when installed on an inactivated screen through light passing through unetched portions of said image and said image being transparent/translucent on an activated screen.

2. The screen protector of claim 1, wherein said screen protector substrate is made from a material chosen from the group consisting of tempered glass, plastic, wood, fabric, metal, fiber, stone, natural material, synthetic material, and composite material.

3. The screen protector of claim 1, wherein said screen protector substrate is made of tempered glass with a thickness of 0.1 mm to 0.4 mm and a tempering range between 4 H-9 H.

4. The screen protector of claim 1, wherein said image is chosen from the group consisting of graphical images, letters, numbers, and symbols.

5. The screen protector of claim 1, wherein said image has a resolution of dots per inch of 50-2400.

6. The screen protector of claim 1, wherein said chemical process is further defined as a compound chosen from the group consisting of water and alcohol.

7. The screen protector of claim 1, further including an anti-fingerprinting coating on said top surface.

8. The screen protector of claim 1, further including an adhesive layer on a bottom surface of said screen protector substrate for adhering the screen protector substrate to a screen.

9. The screen protector of claim 8, wherein the adhesive layer is an acrylate-based glue with a thickness of 90 to 300 micrometers.

10. The screen protector of claim 8, wherein said screen protector is adhered to a screen through said adhesive layer.

11. The screen protector of claim 10, wherein said screen is one chosen from the group consisting of a mobile phone, a tablet computer, a laptop computer, a flat screen monitor, a flat screen television, a watch face, a display screen on a building, a window, an appliance, furniture, a product display, a vehicle light, a vehicle window, a vehicle windshield, and a vehicle interior display screen.

12. A screen protector and screen, comprising a screen protector substrate including an image etched on a top surface thereof, said image being formed by micro-fractures in said top surface created by a laser and activated by a chemical process, said screen protector substrate operatively attached to said screen through an adhesive layer on a bottom surface of said screen protector substrate, said image being visible when said screen is inactivated through light passing through unetched portions of said image and said image being transparent/translucent when said screen is activated.

13. The screen protector and screen of claim 12, wherein said screen protector substrate is made from a material chosen from the group consisting of tempered glass, plastic, wood, fabric, metal, fiber, stone, natural material, synthetic material, and composite material.

14. The screen protector and screen of claim 12, wherein said screen protector substrate is made of tempered glass with a thickness of 0.1 mm to 0.4 mm and a tempering range between 4 H-9 H.

15. The screen protector and screen of claim 12, wherein said image is chosen from the group consisting of graphical images, letters, numbers, and symbols.

16. The screen protector and screen of claim 12, wherein said image has a resolution of dots per inch of 50-2400.

17. The screen protector and screen of claim 12, wherein said chemical process is further defined as a compound chosen from the group consisting of water and alcohol.

18. The screen protector and screen of claim 12, further including an anti-fingerprinting coating on said top surface.

19. The screen protector and screen of claim 12, wherein the adhesive layer is an acrylate-based glue with a thickness of 90 to 300 micrometers.

20. The screen protector and screen of claim 12, wherein said screen is one chosen from the group consisting of a mobile phone, a tablet computer, a laptop computer, a flat screen monitor, a flat screen television, a watch face, a display screen on a building, a window, an appliance, furniture, a product display, a vehicle light, a vehicle window, a vehicle windshield, and a vehicle interior display screen.

21. A method of making a screen protector, including the steps of:
etching an image into a screen protector substrate by striking a top surface of the screen protector substrate with a laser and creating micro-fractures in the top surface;
forming intervals that allow light to pass through unetched portions of the image;
applying a chemical compound to the screen protector substrate to activate the image and remove residual material;
applying an anti-fingerprinting coating to the screen protector substrate; and
applying an adhesive layer for adhering the screen protector substrate to a screen.

22. The method of claim 21, wherein the screen protector substrate is made from a material chosen from the group consisting of tempered glass, plastic, wood, fabric, metal, fiber, stone, natural material, synthetic material, and composite material.

23. The method of claim 21, wherein the screen protector substrate is made of tempered glass with a thickness of 0.1 mm to 0.4 mm and a tempering range between 4 H-9 H.

24. The method of claim 21, wherein the image is chosen from the group consisting of graphical images, letters, numbers, and symbols.

25. The method of claim 21, wherein the image has a resolution of dots per inch of 50-2400.

26. The method of claim 21, wherein the laser is between 5 and 100 watts and has a speed between 5 mm/s and 1500 mm/s.

27. The method of claim 21, wherein the chemical process is further defined as a compound chosen from the group consisting of water and alcohol.

28. The method of claim 21, wherein the adhesive layer is further defined as an acrylate-based glue with a thickness of 90 to 300 micrometers.

29. A method of protecting a screen and displaying an image, including the steps of:
installing a screen protector onto the screen, wherein the screen protector includes a screen protector substrate having an image etched on a top surface thereof, the image being formed by micro-fractures in the top surface created by a laser and activated by a chemical process; and
displaying the image when the screen is not activated through light passing through unetched portions of the image, and the image becoming translucent or transparent when the screen is activated.

30. The method of claim 29, wherein the screen protector substrate is made from a material chosen from the group consisting of tempered glass, plastic, wood, fabric, metal, fiber, stone, natural material, synthetic material, and composite material.

31. The method of claim 29, wherein the screen protector substrate is made of tempered glass with a thickness of 0.1 mm to 0.4 mm and a tempering range between 4 H-9 H.

32. The method of claim 29, wherein the image is chosen from the group consisting of graphical images, letters, numbers, and symbols.

33. The method of claim 29, wherein the image has a resolution of dots per inch of 50-2400.

34. The method of claim 29, wherein said chemical process is further defined as a compound chosen from the group consisting of water and alcohol.

35. The method of claim 29, wherein said installing step is further defined as applying the screen protector substrate to the screen through an adhesive layer on a bottom surface of the screen protector substrate.

36. The method of claim 35, wherein the adhesive layer is further defined as an acrylate-based glue with a thickness of 90 to 300 micrometers.

37. The method of claim 29, wherein the screen is one chosen from the group consisting of a mobile phone, a tablet computer, a laptop computer, a flat screen monitor, a flat screen television, a watch face, a display screen on a building, a window, an appliance, furniture, a product display, a vehicle light, a vehicle window, a vehicle windshield, and a vehicle interior display screen.
